(19) United States
(12) Patent Application Publication
(10) Pub. No.: US 2014/0278711 A1
(43) Pub. Date: Sep. 18, 2014

(54) Systems Engineering Lifecycle Cost Estimation

(71) Applicant: Professional Project Services, Inc., Oak Ridge, TN (US)

(72) Inventors: George Michael Fuller, Powell, TN (US); Matthew Cody Lambert, Lenoir City, TN (US); Nathan J. Sloan, Seymour, TN (US); Lorie Baker-Wallace, Oak Ridge, TN (US)

(73) Assignee: PROFESSIONAL PROJECT SERVICES, INC., Oak Ridge, TN (US)

(21) Appl. No.: 14/211,852

(22) Filed: Mar. 14, 2014

Related U.S. Application Data
(60) Provisional application No. 61/783,322, filed on Mar. 14, 2013.

(51) Int. Cl. G06Q 10/06

(52) U.S. Cl. CPC G06Q 10/06315
USPC 705/7.25

(57) ABSTRACT

An engineering lifecycle cost estimation system, or EDGE System. The engineering lifecycle cost estimation system allows users to make engineering decisions based on graded evaluations of lifecycle costs (“EDGE”). Embodiments of the EDGE System allow users to analyze major design options during initial system development, optimize system details during final system development and construction, and manage system operation and maintenance over the life of the system. Embodiments of the EDGE System allow users to define a system in terms of the components included in the system, define alternative systems, calculate lifecycle costs for a system or component, and visualize the lifecycle costs, timelines, and other information for systems and components. The visualizations allow users to easily analyze and compare alternative systems or components and make informed decisions. A limited access portal allows clients to manage systems and obtain current lifecycle cost estimates while preserving the integrity of the underlying data.

### BACKGROUND

Conventional lifecycle cost estimation tools perform high level calculations to analyze lifecycle costs on a macro level. For example, conventional lifecycle cost estimation tools are often used to evaluate the lifetime costs associated with facilities (i.e., a major system). To be broadly applicable, such conventional lifecycle cost estimation tools focus on general cost centers (e.g., capital costs or utility costs) applicable to all such facilities.

While convention lifecycle cost estimation tools are useful in evaluating the initial investment and, in some cases, generalized operational costs associated with a system considered during the design phase, they do not have the capability to provide an accurate assessment of the true operational and maintenance cost over the life of the system. Without a proper understanding of the subsystems, components, and subcomponents that make up the system, the actual cost associated with day-to-day operation and maintenance of the system may be greater than what was budgeted.

From a design perspective, conventional lifecycle cost estimation tools do not provide the ability to compare the long term costs associated with the various components considered during the design phase allowing the system designer to make the best choice at the outset. From an operational perspective, conventional lifecycle cost estimation tools are not effective for predicting how many components are likely to fail, approximately when failure of a component is likely to occur, and the approximate cost to repair or replace the failed component.

The lack of detail makes such tools less-than-complete design phase tools and even more unsuitable for operational and maintenance budgeting and other post-design phase functions. It is with respect to these and other considerations that the present invention has been made.

### BRIEF SUMMARY

Various embodiments of an engineering lifecycle cost estimation system, or EDGE System, provide system lifecycle cost analysis at any phase of a project to deliver a defensible and credible decision basis and allow users to create an operation and maintenance (“O&M”) plan which they can update and modify with their actual data to keep a forward looking predictive model of their installed system maintenance requirements. User may analyze alternative systems (i.e., scenarios) to identify the scenario that best meets project requirements, optimize and refine equipment selection, and develop O&M management plans. By incorporating embodiments into a design process, an unbiased selection of cost effective alternatives and equipment may be provided. Lowest lifecycle cost alternatives and equipment may be identified to provide informed capital versus lifecycle cost decisions, an impact of which can be substantial when evaluating systems on an enterprise level.

Embodiments may provide for refinement of technology, equipment, and an approach of selecting a system by determining subsystems and components and developing optimal system lifecycle budgets by cost category. A system design approach may be optimized to include evaluation of best systems and components, allowing a user to understand the full costs of installing a new technology, select components with the lowest out-year maintenance cost, and evaluate staffing/labor impacts on equipment selection. Embodiments may provide for budgeting, scheduling, tracking, and management against an operations and maintenance plan. A schedule for forecasting of operations and maintenance and replacement activities, data for out-year budget requests/projections, and timing for technology insertion to offset obsolescence may be determined and visualized. Embodiments may be utilized to identify opportunities for further optimization, to manage variances between budget and actual costs and schedule, and to make forecast adjustments.

The system may receive project requirements from a client, and depending on where they are in their project lifecycle, it may require receiving component information either from vendors or from them. It will require that those components are combined into a system or a variety of system alternatives, depending again on where the client is in their project. It is calculating the overall lifecycle cost, allowing them to make an unbiased decision, whatever decision it is they need to make based on where they are in the lifecycle of their project.

Embodiments may receive data and then allow a user to make an appropriate decision, either to select an alternative, to select the specific components or to support their budgeting for out-year operation and maintenance costs. Embodiments may use a bottom up calculation method versus an estimated calculation. Defendable data may be provided for allowing a user to make unbiased decisions. Embodiments may allow a user to keep their system updated and live in terms of its lifecycle.

### BRIEF DESCRIPTION OF THE DRAWINGS

Further features, aspects, and advantages of the invention represented by the embodiments described present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 illustrates one embodiment of the high level architecture and external interfaces of the engineering lifecycle cost estimation system;

FIG. 2 illustrates one embodiment of the high level architecture of the engineering lifecycle cost estimation system;

FIG. 3 is a data flow diagram that illustrates the relationships between various components and external interfaces of the engineering lifecycle cost estimation system;

FIG. 4 illustrates one embodiment of a high level flowchart illustrating the major operations of the engineering lifecycle cost estimation system;

FIG. 5 is a flowchart of one embodiment of the import operation;

FIG. 6 is a flowchart of one embodiment of the configure operation;

FIG. 7 is a flowchart of one embodiment of the calculate operation;

FIG. 8 is a flowchart of one embodiment of the visualize operation;

FIG. 9 is a flowchart of one embodiment of the export operation;

FIG. 10A is one embodiment of a line graph visualization depicting obsolete replacement costs using the EDGE System “Manage” function;

FIG. 10B is one embodiment of a line graph visualization depicting a radar systems comparison as part of the EDGE System “Optimize” function;

FIG. 10C is one embodiment of a bar graph depicting a lifecycle cost comparison of four separate system alternatives as part of the EDGE System “Manage” function;

FIG. 11 illustrates one embodiment of the relationship between the main portal and the O&M portal and the functional available to various users of the EDGE System;

FIG. 12A is a segment of one embodiment of a decision tree used by the lifecycle cost calculator to determine which labor rate to use when calculating the planned obsolescence costs;

FIG. 12B is a high level flowchart of one embodiment of a decision tree used by the lifecycle cost calculator to determine the repair/replacement cost of a subcomponent; and

FIG. 13 illustrates an exemplary architecture of a computing device suitable to implement aspects of the present disclosure.

### DETAILED DESCRIPTION

An engineering lifecycle cost estimation system, or EDGE System, is described herein and illustrated in the accompanying figures. The engineering lifecycle cost estimation system allows users to make engineering decisions based on graded evaluations of lifecycle costs (“EDGE”). Embodiments of the EDGE System allow users to analyze major design options during initial system development, optimize system details during final system development and construction, and manage system operation and maintenance over the life of the system. Embodiments of the EDGE System allow users to define a system in terms of the components included in the system, define alternative systems, calculate lifecycle costs for a system or component, and visualize the lifecycle costs, timelines, and other information for systems and components. The visualizations allow users to easily analyze and compare alternative systems or components and make informed decisions. A limited access portal allows clients to manage systems and obtain current lifecycle cost estimates while preserving the integrity of the underlying data.

Embodiments of the present invention provide system lifecycle cost analysis at any phase of a project to deliver a defensible and credible decision basis and allow users to create an operation and maintenance (“O&M”) plan which they can update and modify with their actual data to keep a forward looking predictive model of their installed system maintenance requirements. By using embodiments, a user may be able to analyze alternative systems (i.e., scenarios) to identify the scenario that best meets project requirements, optimize and refine equipment selection, and develop O&M management plans. By incorporating embodiments into a design process, an unbiased selection of cost effective alternatives and equipment may be provided.

Embodiments may be utilized to provide a detailed cost analysis with which to make unbiased decisions regarding return on investment. Lowest lifecycle cost alternatives and equipment may be identified to provide informed capital versus lifecycle cost decisions, an impact of which can be substantial when evaluating systems on an enterprise level. In addition to lifecycle cost data, embodiments may be operable to identify maintenance requirements for providing an O&M budget plan and management tool.

Embodiments may be integrated with existing computerized maintenance management systems (CMMS) and building information management (BIM) design software to provide an accurate management and planning tool for system maintenance. Through an O&M management portal, client users may update the O&M plan based on client specific actuals, thereby improving accuracy of budget forecasts throughout a system's lifespan.

Embodiments provide an independent unbiased assessment of a project's lifecycle cost and bring visibility to operation and maintenance costs, show lifecycle cost impact of capital investments, establish a budget baseline for planning and accountability, and provide unbiased data for management to make defendable decisions.

Embodiments of the present invention may enable a user to select a scenario meeting project requirements by identifying alternatives and determining costs associated with each alternative, select the best systems cost alternatives and return on investment, and providing defendable data for decision making. Users may be enabled to know up-front what a new system, equipment, or technology may cost to own and operate. Users may also be enabled to understand return on investment of capital cost investments against long-term manpower and other operations and maintenance costs. Full lifecycle costs may be compared for planned or existing systems or components and between alternatives.

Embodiments may provide for refinement of technology, equipment, and an approach of selecting a system by determining subsystems and components and developing optimal system lifecycle budgets by cost category. A system design approach may be optimized to include evaluation of best systems and components, allowing a user to understand the full costs of installing a new technology, select components with the lowest out-year maintenance cost, and evaluate staffing/labor impacts on equipment selection.

Embodiments may provide for budgeting, scheduling, tracking, and management against an operations and maintenance plan. A schedule for forecasting of operations and maintenance and replacement activities, data for out-year budget requests/projections, and timing for technology insertion to offset obsolescence may be determined and provided. Embodiments may be utilized to identify opportunities for further optimization, to manage variances between budget and actual costs and schedule, and to make forecast adjustments.

The system may receive project requirements from a client, and depending on where they are in their project lifecycle, it may require receiving component information either from vendors or from them. It will require that those components are combined into a system or a variety of system alternatives, depending again on where the client is in their project. It is calculating the overall lifecycle cost, allowing them to make an unbiased decision, whatever decision it is they need to make based on where they are in the lifecycle of their project.

Embodiments may receive data and then allow a user to make an appropriate decision, either to select an alternative, to select the specific components or to support their budgeting for out-year operation and maintenance costs. Embodiments may use a bottom up calculation method versus an estimated calculation. Defendable data may be provided for allowing a user to make unbiased decisions. Embodiments may allow a user to keep their system updated and live in terms of its lifecycle.

FIG. 1 illustrates one embodiment of the engineering lifecycle cost estimation system operating in a network computing environment. The EDGE System 100 includes the lifecycle cost estimation engine 102 running on an application server 104. In various embodiments, the lifecycle cost estimation engine 102 is in communication with a database management system 106 storing information about systems and components used by the lifecycle cost estimation engine. As used herein, the term “component” broadly encompasses subsystems, components, or subcomponents of a system. The EDGE System 100 maintains various data stores including, but not limited to, a system component library 108 and a system alternatives data store 110. In various embodiments, the system component library 108 may contain information about components available for use in a system. The system alternatives data store 110 holds system definitions created for analysis using the EDGE System 100.

Systems may be defined with components from the system component library 108. Alternative versions of systems may be created. In some embodiments, the EDGE System 100 stores a full definition of a base system and differential definitions of alternative systems, which are linked to the base system. In other embodiments, full definitions of each alternative system are stored separately. As used herein, the term “scenario” may be used to refer to a system or alternative system subject to analysis using the EDGE System 100.

The component information and/or systems may be supplied by the external data sources 112, such as computerized maintenance management system (CMMS) data 114, building information management (BIM) data 116, and vendor system component data 118. Embodiments of the EDGE System 100 may import data files 120 generated by the external data sources 112 or directly interface with the external data sources 112. The system component library 108 and the system alternatives data store 110 may also be manually updated (e.g., direct entry of systems or component data by a user).

Users 122a, 122b may access the EDGE System 100 may from client devices 124 via user agents. The EDGE System 100 may provide different user interfaces exposing access to different levels of functionality to different users. As should be appreciated, data and formula integrity is an important aspect of the EDGE System and developing scenarios. A main portal 126 allows full control over the EDGE System and is generally available to a first group of users 122a. For example, the main portal 126 may be used to globally add, delete, modify, or import calculations, visualizations, alternative systems, component information, connections to external data sources, users, permissions, and other aspects of the EDGE System 100.

An operations and maintenance (O&M) portal 128 may be offered as an alternative user interface to a second group of users 122b The O&M portal balances a client's need for current information while preserving the integrity of the underlying data and formula. In various embodiments, the O&M portal 128 is a subset of the main portal 126. The O&M portal 128 may provide the second group of users 122b with the ability to manage operation and maintenance costs for selected systems, selected entities (e.g., a specific company or division). The second group of users 122b may be able to select systems or components to analyze, set the analysis timeline (e.g., start and end dates), and select the type of analysis to receive current lifecycle cost estimations. According to some embodiments, the O&M portal 128 may be used to modify or add local component i a user is able to adjust selected system and/or component information via to do some level of recalculation to allow the user to have an accurate, forward-looking maintenance plan.

FIG. 11 illustrates one embodiment of the relationship between the main portal 126 and the O&M portal 128 and the functions available to various users of the EDGE System 100. The users generally fall into different groups based on the level of interaction with the EDGE System 100. One group of users includes technical users 1102 (e.g., engineers or system designers) feeding the EDGE System with component data, designing systems or scenarios, and/or developing lifecycle cost models. Administrative users 1104 responsible for global upkeep and security of the EDGE System may form a separate user group. A third user group may include consumers 1106 of the analysis provided by the EDGE System 100. The consumers may be non-technical users (e.g., executives, accountants, and other business-side personnel) or operational personnel (e.g., operations managers, technicians, and other operation-side personnel) who are not responsible for developing systems or scenarios, but benefit from their analysis for purposes such as, but not limited to, planning and budgeting of operational and/or maintenance activities and costs of the life of systems. In various embodiments, the technical users 1102 and administrative users 1104 typically use the main portal 126 but are not restricted from using the O&M portal 128 when the functionality of the main portal 126 is not required. In various embodiments, rather a single main portal, separate portals may be provided for the technical users 1102 and administrative users 1104. In various embodiments, the user agents, the lifecycle cost estimation engine 102, the database management system 106, and/or the external data sources 112 may be linked via a network 130. Examples of suitable networks include, but are not limited to, a personal area networks, local area networks, wide area networks, the Internet, and combinations thereof. In some embodiments, the EDGE System 100 may be implemented as a single computing device, a farm of computing devices, or a distributed system of separate computing devices. In some embodiments, one or more of the lifecycle cost estimation engine, the database management system, the external data sources, and the various data stores may be run and/or stored on the same computing device. In some embodiments, the lifecycle cost estimation engine is accessed locally rather than with a client device and/or user agent.

FIG. 2 is a block diagram of one embodiment of a high level architecture of the lifecycle cost estimation engine 102. In various embodiments, the lifecycle cost estimation engine 102 includes a user interface 202, a security module 210, an administration module 212, a reference module 214, an import module 220, a configure module 222, a calculate module 224, a visualize module 226, an export module 228, and the O&M portal 128.

The user interface 202 provides textual, graphical, and, optionally, audible outputs from various output devices (e.g., video displays, printers, and speakers) and accepts inputs from various input devices (e.g., a keyboard, mouse, touch screen, or microphone) allowing users to interact with the other modules of the lifecycle cost estimation engine 102. The input devices and output devices may be local (i.e., at the lifecycle cost estimation engine server) or remote (i.e., at the client device). In various embodiments, the user interface 202 includes one or more interface types including, but not limited to, menu, form, point-and-click, drag-and-drop, touch, gesture, voice recognition, and natural user interfaces. For example, the user interface 202 may be implemented via hypertext markup language (HTML) or extensible markup language (XML) documents displayable by the user agent (e.g., a web browser) running on the client device. The HTML or XML documents may be served to the client device from the lifecycle cost estimation engine server. In another embodiment, the user interface is displayed by a client application (i.e., the user agent) running on the client device and communicating with the primary lifecycle cost estimation engine. In another embodiment, the user interface is provided by the lifecycle cost estimation engine on the local computing device or on the client device through a terminal. The user interface is involved in various aspects of the EDGE System including, but not limited to, selecting a source of system component information for importing; selecting certain options for configuring system alternatives; selecting system alternatives to calculate, selecting data to visualize, and selecting data to export.

The security module 210 restricts access to some (i.e., a subset) or all of the functionality and/or data of the lifecycle cost estimation engine 102. In various embodiments, the restrictions are based on roles or permissions assigned to the user.

The administration module 212 controls authorization and access to the lifecycle cost estimation engine 102. In one embodiment, an administrator may maintain system component and alternative information, add or delete users 216, update the role or permissions associated with users or functionality, and configure external connections (e.g., creating and/or authorizing links to and connections from other systems and applications including, but not limited to, selected client devices, database management servers, selected databases, external CMMS tools, CMMS servers, external BIM design software, BIM servers, and Vendor system component data).

The reference module 216 allows users to link reference data from the database management system 106 or other authorized source with the system component library data or the system alternatives data. In various embodiments, the reference data is linked when the system component library data is imported, or when one or more system alternatives are generated by the lifecycle cost estimation engine 102. Examples of reference data include, but are not limited to, original system component information, maps, videos, pictures, audio files, multimedia images, and other static data.

The import module 220, configure module 222, calculate module 224, visualize module 226, and export module 228 are used by the lifecycle cost estimation engine 102 to perform the operations shown on FIG. 4 and described in detail below.

In various embodiments, O&M portal 128 allows users to manage operations and maintenance costs. According to some embodiments, a user is able to adjust data via the O&M portal to do some level of recalculation to allow the user to have a more accurate, forward-looking maintenance plan. In various embodiments, the O&M portal may be utilized to make adjustments to consumables. For example, if the price of gas rises (e.g., from $0.99 to $1.40), a user can use the O&M portal to adjust the price of gas to see how an O&M cost over a time period may be affected. In further embodiments, a new calculation may be performed for major changes. For example, if equipment is going to be utilized in an environment where the life of the equipment may be shortened due to the environmental conditions, the reliability factor for components may be adjusted and a new calculation performed. In such a case, a lifecycle cost may be provided, which may include a number of spare parts needed, an estimated labor force, a cost to maintain the system, etc.

In various embodiments, the O&M portal may include risk ranking of critical components. For example, a user may be able to calculate, based on risk, an amount of maintenance that may be deferred to save maintenance costs. For example, if a user's budget is cut, the user may be able to see at what point deferred maintenance may become critical. Additionally, the O&M portal allows a user to make changes according to certain constraints and determine how a budget forecast may need to change.

FIG. 3 is a data flow diagram of one embodiment of the EDGE System showing the relationship between a client's BIM design software, a client's CMMS engine, a system component library database, the lifecycle cost calculator, and the O&M portal. In one embodiment, data flow begins with importing system component information into the system component library 108, where information on the components and subcomponents that include a system may be collected. In various embodiments, data may be imported into the system component library from one or more external data sources 112. In one embodiment, the system component library is a database with a web services interface. In various embodiments, a user may be able to interact with the system component library via a web page that allows him to edit data, add data, remove data, etc.

Component information may include, but are not limited to, reliability factors, obsolescence factors, costs, and usage data. Some examples of reliability factors mean time between failure (MTBF), mean time to failure (MTTF), mean time between repair (MTBR), and mean time to repair (MTTR). Some examples of costs include repair costs, replacement costs, consumable costs, and labor rates. Some examples of usage data are time of operation per period (e.g., hours operated per day and days of operation per week).

The component information may be reference data generally applicable to all systems (e.g., reliability factors supplied by manufacturers, national average utility rates, or U.S. General Services Administration costs) or actual data specific to a particular client, site, geographical region, or climate, other distinguishing property (e.g., actual reliability factors measured by a client, the actual utility rates for the utility providing service to a client, or the actual pricing by vendors supplying the client). System component data may include site-specific component data such as labor rates, or factors that are very specific to how operations work at a given site. For example, if a client is a nuclear facility that utilizes various layers of security, and a project is to be implemented inside a high security zone, there may be a two man rule and a significant amount of training that may be required. Embodiments of the EDGE System may factor in client-specific data to provide an accurate cost associated with a project. Embodiments may take into account an operational component. Various scenarios may be calculated to determine a cost associated with moving a system (e.g., moving a component outside of a security fence versus inside a security fence). For example, the EDGE System may be used to determine whether it more cost effective for the extra design and construction cost to move the component outside the security fence versus the higher maintenance labor costs to have a crew operate inside the security fence over the system lifecycle.

As illustrated, the system component library may include data from a client's CMMS, which may include actual data that is more representative of what the client is experiencing over standard vendor data. For example, data from a client's CMMS may provide information pertaining to how components and subcomponents may actually be performing (e.g., reliability factors). This data may be stored in the system component library and be used for the client specifically so that when calculations are performed via the lifecycle cost calculator, results may be specific to the operating conditions that the client is experiencing.

According to one embodiment, an application or service may be provided for interfacing with the client's CMMS engine. The format of the data stored in the CMMS engine may be recognized, and the data may be formatted in a manner in which the system component library needs. Accordingly, a transformation or translation of the data may be performed. An identifier may be utilized to ensure the data from the CMMS engine is stored in a correct part of the system component library and does not override the client's data or manufacturer's data. Accordingly, the interfacing application may be operable to perform the transformation and update the component library.

As an example, a client, such as the branch of the military, may wish to analyze the lifecycle cost of a component, such as security cameras. Information may be analyzed and reported by grouping sites/locations on one or more criteria such as geography. Depending on the location of a military base (e.g., Alaska versus a base on the coast versus someplace that has other extremes of temperature or weather), actual performance of the components may be analyzed. Geographically, how the components are performing overall may provide clients with useful information.

Some clients, for example, may prequalify vendors to supply components based on certain operational data and their ability to meet certain specifications (e.g., military specifications) or other criteria. By utilizing client data, a client may be able to see how a component is actually performing versus specification data provided by a vendor.

A client may agree to share CMMS data with other clients. Using the system component library, multiple system alternatives may be quickly configured and stored in the system alternatives data store. For example, information for a similar component may be used for calculations instead of retrieving component-specific information. The system component library may also include a security feature, for example, data isolation. Embodiments have the ability to operate separately in a classified environment.

BIM data provides digital representations of physical and functional characteristics of a facility or other system. A lifecycle cost of components in a building information model may be determined and stored in the system component library. The EGDE System 100 may combine BIM information, such as the types and number of HVAC units with component information about the various HVAC units obtained from the system component library to calculate and visualize the comparative total lifecycle costs before the design is finalized. For example, studying the visualizations produced by the EDGE System, the user may find that lifecycle costs of a first HVAC unit may be less than lifecycle costs of a second HVAC unit, even though the first HVAC unit may have a higher capital cost. Instead of making design choices based solely on advertising and purchase price, informed design choices may be made factoring in initial investment and total lifecycle costs according to the constraints of the project.

As described above, the system component library may include vendor data. In one embodiment, families of vendor data 302, which may include architectural, engineering, and/or construction (A/E/C) information, may be received and used to populate the system component library. Embodiments may utilize this purchased family of data to feed BIM design software and to more effectively feed the system component library. As shown in FIG. 3, an automated bill of material 304 may be provided by the BIM, which may be fed into a client's CMMS. As can be appreciated, the more efficiently a client can feed their CMMS engine. Greater availability of actuals in the system component library 108 generally results in more accurate estimations of the lifecycle cost for the system. For example, studying the visualizations produced by the EDGE System, the user may find that lifecycle costs of a first HVAC unit may be less than lifecycle costs of a second HVAC unit, even though the first HVAC unit may have a higher capital cost.

The data stored in the system component library 108 is available for use in multiple system alternative design scenarios in the same lifecycle cost evaluation or across multiple projects, as applicable. These system alternative design scenarios are stored in the system alternatives data store 110. System alternatives may include the same component, different numbers of the same component, or they may include some of the same components, but not others.

The EDGE System 100 includes a calculator 310. In various embodiments, the lifecycle cost calculator may be an application running on a web server which interfaces with the database management system. According to one embodiment, the lifecycle cost calculator may include over 415,000 formulas and 4,000 decisions. Using a decision tree with logic, the lifecycle cost calculator may be operable to determine which, when, and where calculations may be used to accumulate costs, and when calculated annual costs may be applied to an appropriate graphic or worksheet. FIG. 12A is a segment of one embodiment of a decision tree used by the lifecycle cost calculator to determine which labor rate to use when calculating the planned obsolescence costs. FIG. 12B is a high level flowchart of one embodiment of a decision tree used by the lifecycle cost calculator to determine the repair/replacement cost of a subcomponent. The decision tree segment is representative of the underlying decisions made by the lifecycle cost calculator for each of the components and subcomponents evaluated as part of the lifecycle cost estimation calculations.

Continuing with FIG. 3, visualizations 312 may be provided to a user or client. Visualizations may include, but are not limited to, graphs, charts, and reports. Visualizations may look different depending on a phase of a system or project, for example, if there is an existing system and the client wants to know how to manage it. The EDGE System 100 may provide hundreds of reports and graphs and charts at any level of detail.

The O&M portal 128 may be made available to the lifecycle cost calculator via a web page or application on a smart phone/tablet. As described above, the O&M portal may allow a user to manipulate some of the data (e.g., consumables, etc.), allowing the user to keep their own end plan and budget forecast up to date. When a user manipulates data, such as a price of a consumable, it may automatically show that reflection in future reports. The user may be presented with a reports screen showing the effect of the manipulated data.

FIG. 4 is a high level flowchart illustrating one embodiment of a method of utilizing the EDGE System 100. The high level operations of the method 400 include an import operation 410 for importing system component information to the system component library, a configure operation 420 for configuring and generating system alternatives, a calculate operation 430 for calculating the lifecycle cost for each alternative system to be evaluated, a visualization operation 440 for visualizing certain data, and an export operation 450 for exporting certain data.

FIG. 5 is a high level flowchart of the sub-operations of one embodiment of the import operation 410 performed by the import module 220. The import operation begins with a source selection sub-operation 510 that provides a user interface 202 allowing the user to provide system component information to the system. The user 126 may select some (e.g., a subset) or all system component information from a selected source. In one embodiment, system component information is obtained from a client's CMMS tool 114. Embodiments of the CMMS tool 114 may contain system component information obtained from BIM design tools 116. In another embodiment, system component information is obtained from one or more vendors with manufacturer system component data.

Following the source selection sub-operation 510, a retrieval sub-operation 520 retrieves the system component information from the selected source. In one embodiment, retrieval of the system component information may be accomplished via multiple queries executed directly against the external CMMS tool 114. For example, the system component information may be obtained directly from a database maintained by the external CMMS tool using an API offered by the external CMMS tool provider. In some embodiments, the external system component information is exported from the external CMMS tool in an intermediate format that can be imported by the EDGE System. In other embodiments, some or all of the system component information created and/or used by the external CMMS tool is in a non-electronic format that cannot be directly accessed by the lifecycle cost estimation engine. Embodiments of the EDGE System retrieve such external system component information by providing a user interface, which allows the user to manually enter or scan system component information from printed or handwritten documents.

The system component storage sub-operation 530 stores the system component information in a form accessible by the EDGE System for use in configuring and generating system alternatives and calculating their lifecycle costs. In various embodiments, the system component information is stored within the system component library 108 of the EDGE System in an electronic format directly or indirectly accessible by the lifecycle cost estimation engine. For example, system component information may be stored in an application specific database or file or a general application or system file (e.g., a spreadsheet or comma separated value document) that may be loaded or queried by the lifecycle cost estimation engine. In other embodiments, some or all system component information may be stored in a non-electronic format (e.g., printed reports or handwritten information) that cannot be directly accessed by the lifecycle cost estimation engine and require user involvement to input the system information. As used herein, the import operation 410 broadly encompasses, without limitation, loading, importing, accessing via an interface such as an application program interface (API), manual entry, optical recognition of scanned reports or other images (and any associated training), and other techniques for entering or transferring data to the EDGE System.

FIG. 6 is a high level flowchart of the sub-operations of one embodiment of the configure operation 420 performed by the configure module 222. The configure operation 420 begins with a Define System Alternatives sub-operation 610. In one embodiment, a user selects system component information using the interface 202 to define at least one, but as many as three, distinct system alternatives for lifecycle cost calculation.

At sub-operation 620, the configure module retrieves all necessary data from the system component library 108 to populate the system alternatives defined by the user at sub-operation 610. The configure operation 420 ends with sub-operation 430 when the configure module stores all data retrieved at sub-operation 620 as distinct, configured system alternatives in the system alternatives data store 110.

FIG. 7 is a high level flowchart of the sub-operations of one embodiment of the calculate operation 430 performed by the calculate module 224. The calculate operation 430 calculates total lifecycle costs for each alternative system to be evaluated by the EDGE System. The calculate operation 430 begins with sub-operation 710 when the calculate module retrieves all data necessary to complete calculations from the system alternatives data store 110. In various embodiments, the results are calculated and stored as the corresponding component information is obtained. Pre-calculating and storing the results reduces the time needed to generate visualizations by adding the calculation to the component selection and data entry process. Automatically pre-calculating and storing the results as component information is stored may also reduce the likelihood that visualizations will be generated using out-of-date calculations after component information is updated. The pre-calculated results may be stored with the systems (e.g., in the system alternatives data store), with the corresponding component information (e.g., in the system component library), or in a separate data store.

At sub-operation 712, the lifecycle timeline is set for evaluation using a number of user-entered inputs. In one embodiment, a user enters the beginning and end years for evaluation via the interface 202. At sub-operation 714, the calculate module sets the alternative system to be calculated to one, and at sub-operation 716, the calculate module sets the evaluated year to the begin date input by the user as part of sub-operation 712.

Design and construction costs, the first of nine separate lifecycle cost components, is calculated at sub-operation 718 by the calculate module. At sub-operation 720 staffing costs are calculated. Replacement for obsolescence costs are calculated at sub-operation 722, and on-call maintenance costs are calculated at sub-operation 724. At sub-operation 726, consumables costs are calculated. Training, documentation, and approval costs are calculated at sub-operation 728. Escalated and present value costs, the last of the nine lifecycle cost components, are calculated at sub-operation 730.

At sub-operation 732, the calculate module increments the evaluation year by determining at decision 734 whether or not the year being evaluated is equal to the end year date plus one. If the answer is “no”, then the evaluation year is incremented to the next year and each of the nine cost components is calculated at sub-operations 718 through 730 for the next evaluation year. If the answer is “yes”, all costs for each component for each year to be evaluated have been calculated for the alternative system set at sub-operation 714, and the calculate module moves on to sub-operation 736.

At sub-operation 736, the calculate module increments the alternative system to be evaluated by determining at decision 738 whether or not the alternative just evaluated is greater than 3. If the answer is “no”, then the alternative is incremented to the next alternative, the evaluation year is reset to the begin year at sub-operation 716, and each of the nine cost components is calculated at sub-operations 718 through 730 for the next alternative. If the answer is “yes”, all calculations for each alternative are complete, and the calculate module has completed the calculate operation 430.

FIG. 8 is a high level flowchart of the sub-operations of one embodiment of the visualize operation 440 performed by the visualize module 226. The report operation 440 begins with sub-operation 810 when data is selected by the user via the interface 202 for visualization. A user may then select the report type(s) desired to be visualized using the interface 202 at sub-operation 820. In various embodiments, report types that may be visualized using the EDGE System include, but are not limited to, tables, charts, and graphs. The visualize module then generates the appropriate reports depicting the selected data at sub-operation 830.

FIG. 9 is a high level flowchart of the sub-operations of one embodiment of the export operation 450 performed by the export module 228. The export operation allows the total lifecycle cost data created using the calculate module 324 and the reports generated by the report module 326 to be exported to the O&M portal 128. The export operation begins with sub-operation 910 when target data to be exported is selected by a user via the interface. A user may then select the source(s) he/she wishes to update via the interface at sub-operation 920. In various embodiments, sources to be updated may include, but are not limited to, the O&M portal 128, CMMS tools 114, BIM design tools 116, and vendor system component data stores 118. At sub-operation 930, the appropriate data is exported to the selected source(s) by the export module.

FIGS. 10A, 10B, and 10C illustrate embodiments of reports generated by the visualize module 226 and a representative of the types of output and data that the EDGE System may provide in support of a project, depending on where one is in a project's lifecycle development, from concept to design and construction to operations and maintenance. In various embodiments, visualizations may be interactive, wherein a user may be able to select a data point via the user interface 202 and information about the calculations performed as part of operation 430 may be provided.

FIG. 10A is one embodiment of a line graph visualization depicting obsolete replacement costs using the EDGE System “Manage” function. The following example starts at the back end of a project's lifecycle development, with what is referred to as a management operation. When a system is installed, a user, who may be an owner of the system, may need to figure out the costs to operate and maintain the system. The EDGE System displays specific information across multiple different cost categories. The graph illustrated in FIG. 10A shows one cost category for an installed system that looks at replacements for obsolescence as opposed to repair/replacement based on failure. The user is able to decide what components to analyze for obsolescence (e.g., the likelihood that technology for a chosen component is going to improve and potentially reduce the lifecycle costs associated with the component). So in an HVAC system, for example, a user may look at when the system will obsolesce to make sure that it is being sustained.

The graph in FIG. 10A is one of the cost specific graphs that shows cost categories and expected costs on a year-by-year basis. In various embodiments, the EDGE System provides annual costs, but also accrued costs over time. By way of example only, a user (e.g., an operations and maintenance manager) could view the graph and see that there may be a problem in 2019 because it may be hard to manage the peak. He may be enabled to see that there is something big going on at year 2019. That user may be able to select points on the graph via the user interface by clicking on the peak, and the visualization would show every component that is obsolescing in that year. In various embodiments, the physical location of components may also be visualized via the user interface. In the example case study illustrated by FIG. 10A, the components were installed over a ten year basis. Each component is evaluated by the EDGE System based on its actual installation date. The curve demonstrates that there are some major systems going obsolete in 2019, one of which is a centralized encryption system. According to various embodiments, the EDGE System allows a user to look at each cost type. While the illustrated case study is looking at obsolescence, a user may look at this same detail for any of the cost categories, including but not limited to, replacement parts, labor, energy, etc. A user may look at this level of graph and see where are the problems are going to be, where the peaks are, etc. Accordingly, decisions may be made to determine how to budget for or plan around such challenges.

A user may look at the graph in FIG. 10A, and in this case, looking at obsolescence, he may determine to start evaluating the changes in technology for that component early, i.e. in 2016 or 2017. This provides the user time to assess technology evolution with various vendors and other sources, and then make an informed decision on the need to replace the component for obsolescence or not, or re-set the obsolescence date. By providing a forward looking evaluation of obsolescence, managers have time to address technology turnover before it impacts their system. If a different peak on the visualization looking at, for example, mean time to replace, a different decision may be made. For example, a user may determine that in order to manage a peak, he may replace some percentage of components early and then some percentage of components late. A critical risk profile may be analyzed to help make those decisions so that a user can address a peak through a proactive management approach. Addressing an obsolescence peak is a little bit different because the user may have to determine the state of technology today.

FIG. 10B is one embodiment of a line graph visualization depicting a radar systems comparison as part of the EDGE System “Optimize” function. Such a visualization provides useful information during the design process of a project's development lifecycle, and may be referred to as an optimization operation. During an optimization operation, a user may already know what a system is going to look like, but is determining the exact components to use. The graph shown in FIG. 10B illustrates a tradeoff analysis between four different radar units that all meet the specifications for a particular component of the system. In this example, radars are a known component, and the number of radars has been determined. The question the visualization in FIG. 10B can help a user answer is which is the best radar from a lifecycle perspective. While a user may face any number of choices, this figure graphically depicts lifecycle costs for four different radar units. The graph illustrates an accumulated cost, which may help put into perspective a lifecycle cost of a component over time. For example, the graph shows that, according to accumulated cost, Radars 3 and 4 may be the best two choices; however, other variables may be considered that may justify incurring a higher lifecycle cost.

FIG. 10C is one embodiment of a bar graph depicting a lifecycle cost comparison of four separate system alternatives as part of the EDGE System “Manage” function. Such a visualization provides useful information during the concept phase of a project's development lifecycle, and may be referred to as an analysis operation. This figure depicts the beginning of a project lifecycle when a user may be looking at design concepts and alternatives to allow decision makers to make unbiased decisions based on total lifecycle cost. The graph shown in FIG. 10C illustrates a total lifecycle cost comparison of various system alternatives. During an analysis operation, a user is looking at various system alternatives so that decisions regarding how to design a particular system may be answered. The graph in FIG. 10C illustrates five system alternatives for comparison. In this particular case, the capital cost of each system alternative is not included so that lifecycle costs from the time an alternative is installed may be examined and compared by a user. In this particular case, this graph shows a large cost is associated with the labor force, as well as how each system alternative uses technology to mitigate labor. As a further example of the benefits associated with this type of visualization, a user may be enabled to understand what level of work force it may take to operate a system. In an example of a security system where some component becomes inoperable, somebody may be required to stand post until the system is operational. The EDGE System may take into account compensatory measures for system downtime.

FIG. 13 illustrates an exemplary architecture of a computing device that can be used to implement aspects of the present disclosure. The computing device may be used to execute the operating system, application programs, and software modules (including the software engines) described herein.

The computing device 1310 includes, in some embodiments, at least one processing device 1380, such as a central processing unit (CPU). A variety of processing devices are available from a variety of manufacturers, for example, Intel or Advanced Micro Devices. In this example, the computing device 1310 also includes a system memory 1382, and a system bus 1384 that couples various system components including the system memory 1382 to the processing device 1380. The system bus 1384 is one of any number of types of bus structures including a memory bus, or memory controller; a peripheral bus; and a local bus using any of a variety of bus architectures.

Examples of computing devices suitable for the computing device 1310 include a desktop computer, a laptop computer, a tablet computer, a mobile computing device (such as a smart phone, a tablet device, or other mobile devices), or other devices configured to process digital instructions.

The system memory 1382 includes read only memory 1386 and random access memory 1388. A basic input/output system 1390 containing the basic routines that act to transfer information within computing device 1310, such as during start up, is typically stored in the read only memory 1386.

The computing device 1310 also includes a secondary storage device 1392 in some embodiments, such as a hard disk drive, for storing digital data. The secondary storage device 1392 is connected to the system bus 1384 by a secondary storage interface 1394. The secondary storage devices 1392 and their associated computer readable media provide nonvolatile storage of computer readable instructions (including application programs and program modules), data structures, and other data for the computing device 1310.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 1392 or memory 1382, including an operating system 1396, one or more application programs 1398, other program modules 1300 (such as the software engines described herein), and program data 1302. The computing device 1310 can utilize any suitable operating system, such as Microsoft Windows™, Google Chrome™, Apple OS, and any other operating system suitable for a computing device. Other examples can include Microsoft, Google, or Apple operating systems, or any other suitable operating system used in tablet computing devices.

In some embodiments, a user provides inputs to the computing device 1310 through one or more input devices 1304. Examples of input devices 1304 include a keyboard 1306, mouse 1308, microphone 1310, and touch sensor 1312 (such as a touchpad or touch sensitive display). Other embodiments include other input devices 1304. The input devices are often connected to the processing device 1380 through an input/output interface 1314 that is coupled to the system bus 1384. These input devices 1304 can be connected by any number of input/output interfaces, such as a parallel port, serial port, game port, or a universal serial bus. Wireless communication between input devices and the interface 1314 is possible as well, and includes infrared, BLUETOOTH® wireless technology, 802.11a/b/g/n, cellular, or other radio frequency communication systems in some possible embodiments.

In this example embodiment, a display device 1316, such as a monitor, liquid crystal display device, projector, or touch sensitive display device, is also connected to the system bus 1384 via an interface, such as a video adapter 1318. In addition to the display device 1316, the computing device 1310 can include various other peripheral devices (not shown), such as speakers or a printer.

When used in a local area networking environment or a wide area networking environment (such as the Internet), the computing device 1310 is typically connected to the network 1312 through a network interface 1320, such as an Ethernet interface. Other possible embodiments use other communication devices. For example, some embodiments of the computing device 1310 include a modem for communicating across the network.

The computing device 1310 typically includes at least some form of computer readable media. Computer readable media includes any available media that can be accessed by the computing device 1310. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1310.

The computing device illustrated in FIG. 13 is also an example of programmable electronics, which may include one or more such computing devices, and when multiple computing devices are included, such computing devices can be coupled together with a suitable data communication network so as to collectively perform the various functions, methods, or operations disclosed herein.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method of facilitating analysis of estimated lifecycle costs over a period of time, the method comprising the acts of:
defining a plurality of alternative lifecycle scenarios having multiple components;
obtaining component data for each alternative lifecycle scenario;
calculating periodic costs for each component; and
visualizing the periodic costs for at least one component in the alternative lifecycle scenario.

2. The method of claim 1 wherein component data is obtained from at least one of a computerized maintenance management system, a building information modeling system, vendor data, and manufacturer data.

3. The method of claim 1 further comprising the act of calculating an accumulated component cost for each component.

4. The method of claim 3 wherein the act of visualizing the periodic costs for at least one component in the alternative lifecycle scenario comprises the act of simultaneously displaying the accumulated component costs for at least two components.

5. The method of claim 1 further comprising the act of calculating a total lifecycle cost for each alternative lifecycle scenario.

6. The method of claim 5 wherein the act of visualizing the periodic costs for at least one component in the alternative lifecycle scenario comprises the act of simultaneously displaying the total lifecycle costs for at least two alternative lifecycle scenarios.

7. The method of claim 1 wherein the periodic costs calculated comprise at least one of obsolescence costs, maintenance costs, training costs, documentation costs, and approval costs.

8. The method of claim 7 wherein the periodic costs calculated further comprise at least one of design costs, construction costs, staffing costs, and approval costs.

9. The method of claim 1 further comprising the act of calculating present values and escalated values for the periodic costs for each component.

10. The method of claim 1 further comprising the act of generating an operation and maintenance plan using the component data and periodic costs for a selected alternative lifecycle scenario.

11. The method of claim 1 further comprising the act of forecasting windows for technology insertion to offset obsolescence.

12. A engineering lifecycle cost estimation system for predicting lifecycle costs associated with lifecycle scenarios, the engineering lifecycle cost estimation system comprising:
a system alternative data store operable to store lifecycle scenarios for analysis;
a system component library operable to store component data about system components used in the lifecycle scenarios;
a component cost calculator operable to calculate periodic costs associated with each system component, periodic costs associated with each lifecycle scenario, and total lifecycle costs associated with each lifecycle scenario using the component data for the system components used in the lifecycle scenarios;
a visualization engine operable to generate visualizations of the periodic costs associated with each system component and the total lifecycle costs associated with each lifecycle scenario; and
a display for presenting the visualization for consumption by a user.

13. The engineering lifecycle cost estimation system of claim 12 further comprising an interface for obtaining component data from a building information management design tool.

14. The engineering lifecycle cost estimation system of claim 12 wherein the component cost calculator is further operable to use maintenance cost data from a computerized maintenance management system to estimate maintenance costs for an operation and maintenance plan.

15. The engineering lifecycle cost estimation system of claim 12 wherein the component data include general data and customer-specific data.

16. The engineering lifecycle cost estimation system of claim 15 further comprising an operations and management portal allowing end users to modify their own customer-specific data in the system component library and generate visualizations using the visualization engine.

17. The engineering lifecycle cost estimation system of claim 12 wherein the component cost calculator is operable to calculate at least one of replacement for obsolescence costs, on-call maintenance costs, consumable costs, training costs, and document and approval costs.

18. The engineering lifecycle cost estimation system of claim 17 wherein the visualization engine is operable to generate an operation and maintenance plan for a selected lifecycle scenario using at least one of replacement for obsolescence costs, on-call maintenance costs, consumable costs calculated by the component cost calculator.

19. The engineering lifecycle cost estimation system of claim 12 wherein the visualization engine is operable to generate visualizations comparing total lifecycle costs for alternate lifecycle scenarios and for at least one selected component from alternate lifecycle scenarios.

20. A computer readable medium containing computer executable instructions which, when executed by a computer, perform a method for estimating engineering lifecycle costs, the method comprising the steps of:
defining a plurality of alternative lifecycle scenarios having multiple components;
obtaining component data for each alternative lifecycle scenario;
calculating periodic costs for each component; and
visualizing the periodic costs for at least one component in the alternative lifecycle scenario.
